(19) United States
(12) Patent Application Publication
(10) Pub. No.: US 2005/0232451 A1
(43) Pub. Date: Oct. 20, 2005

(54) Notebook having attachable speaker device

(76) Inventor: Tseng Tien Peng, Chong Ho City (TW)

Correspondence Address: Tseng Tien Peng, P.O. Box 10-69, Chong Ho, Taipei, 235, TW

(21) Appl. No.: 10/829,307

(22) Filed: Apr. 19, 2004

(51) Int. Cl. H04R 5/02; H04R 1/02; H04R 9/06

(52) U.S. Cl. 381/306; 381/333; 381/388

(57) ABSTRACT

A notebook computer includes a monitor having a frame, a speaker device having a housing to receive one or more speaker members. The housing includes a casing having a space to receive the frame and to attach the casing and the housing to the frame of the monitor. A spring blade or one or more fasteners may further be used to secure the speaker device to the monitor, for allowing the speaker device to be easily carried with the monitor. The securing device includes one or more fasteners to secure the casing and the housing to the frame of the monitor, or may include an adhesive member to secure the casing to the frame of the monitor.

The present invention is related to U.S. patent application Ser. No. 10/779,229, filed 11 Feb. 2004, pending.

### BACKGROUND OF THE INVENTION

1. Field of the Invention

The present invention relates to a notebook computer, and more particularly to a notebook computer having a speaker device attachable thereto and detachable therefrom.

2. Description of the Prior Art

Typical notebook computers comprise an inbuilt speaker device provided and engaged therein. However, the inbuilt speaker device normally include a quality that is good enough for generating sounds only, but may not provide stereo or Hi-Fi stereo for users.

Accordingly, an outer or additional speaker device is further required to be provided and coupled to the typical notebook computers for providing better quality of sounds or stereo for the users.

However, the outer or additional speaker devices are normally required to be disposed on top of the computer desks and may thus occupy additional spaces of the computer desks. The computer desks may normally be occupied by computers, printers, monitors, or the other peripheral facilities and may have no spare spaces to support the outer or additional speaker devices.

In addition, when the notebook computers are carried outdoors by the users, there will be no suitable spaces or supporting devices to support the outer or additional speaker devices, and it will be difficult to couple the speaker devices to the notebook computers.

The present invention has arisen to mitigate and/or obviate the afore-described disadvantages of the conventional notebook computers.

### SUMMARY OF THE INVENTION

The primary objective of the present invention is to provide a notebook computer including a speaker device attachable thereto and detachable therefrom.

The other objective of the present invention is to provide a notebook computer including a speaker device having a resilient clamping device for detachably attach the speaker device to the notebook computer.

In accordance with one aspect of the invention, there is provided a notebook computer comprising a monitor including a frame, a speaker device including a housing having a casing, and the casing including a space formed therein to receive the frame and to attach the casing and the housing to the frame of the monitor, and the speaker device including at least one spring blade extended therefrom, to engage with the frame of the monitor, and to secure the speaker device to the monitor.

The casing includes two side plates to define the space thereof and to receive the frame. The spring blade is extended from either of the side plates of the casing. Either of the side plates includes an opening formed therein to form the spring blade.

One or more adhesive member may further be provided and attached to the casing, to engage with and to secure the casing to the frame of the monitor.

The casing includes two side plates and an upper plate to define the space thereof and to receive the frame, the adhesive member is attached to either of the plates of the casing.

An adhesive member may further be provided and attached to the spring blade, for engaging with the frame of the monitor, and for further securing the casing to the frame of the monitor.

A securing device may further be provided for securing the casing to the frame of the monitor. The securing device includes at least one fastener engaged through the casing and engaged with the frame of the monitor, to secure the casing and the housing to the frame of the monitor.

The fastener includes a knob and a threaded shank extended from the knob to engage through the plate of the casing. The fastener includes a follower attached to the threaded shank, to engage with the frame of the monitor. The follower includes a pad attached thereto, to engage with the frame of the monitor.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a front perspective view of a notebook computer in accordance with the present invention having speaker devices attached thereto;

FIG. 2 is a rear perspective view of the notebook computer having the speaker devices attached thereto;

FIG. 3 is a front perspective view of the speaker device of the notebook computer;

FIG. 4 is a rear perspective view of the speaker device of the notebook computer;

FIG. 5 is a partial exploded view of the speaker device of the notebook computer;

FIG. 6 is front plan view of the speaker device of the notebook computer; and

FIG. 7 is a partial cross sectional view of the notebook computer, taken along lines 7-7 of FIG. 6.

### DETAILED DESCRIPTION OF THE PREFERRED EMBODIMENT

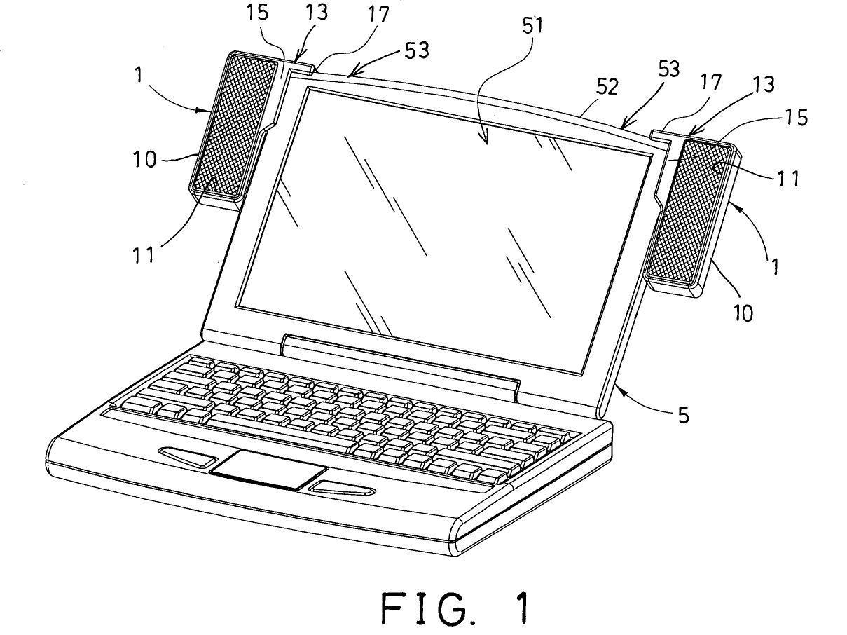

Referring to the drawings, and initially to FIGS. 1-5, a notebook computer in accordance with the present invention comprises a monitor 5 including a screen 51 provided in an outer or peripheral frame 52 which includes two corner areas 53 for attaching one or more speaker devices 1 thereto.

Each of the speaker devices 1 includes a housing 10 having a chamber 11 formed therein for receiving one or more speaker members 12 therein. For example, one or more speaker members (not shown) may be disposed and retained in the chamber 11 of the housing 10.

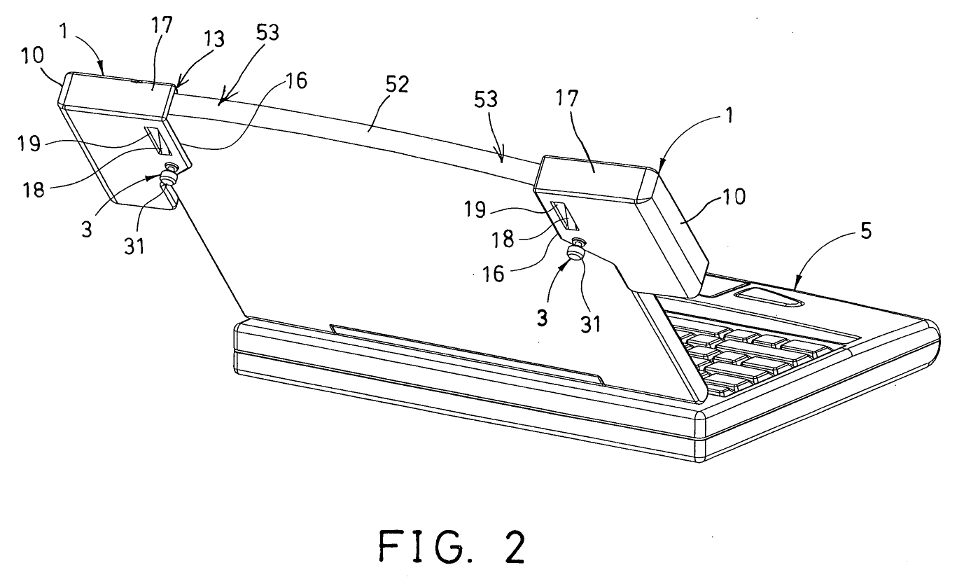

Each of the speaker devices 1 further includes a casing 13 attached to or extended from or provided on the housing 10 and having a space 14 formed therein for receiving either of the corner areas 53 of the peripheral frame 52 of the monitor 5 (FIGS. 1, 2), and thus for attaching the speaker devices 1 onto the monitor 5 of the notebook computer.

For example, each of the casings 13 includes two opposite or side plates 15, 16, and an upper plate 17 to form or define the space 14 thereof, and to stably receive either of the corner areas 53 of the peripheral frame 52 of the monitor 5 therein. The side plates 15, 16 may include suitable resilience to solidly attach or secure the casing 13 and thus the housing 10 of the speaker device 1 to the monitor 5 of the notebook computer with such as force-fitted engagements.

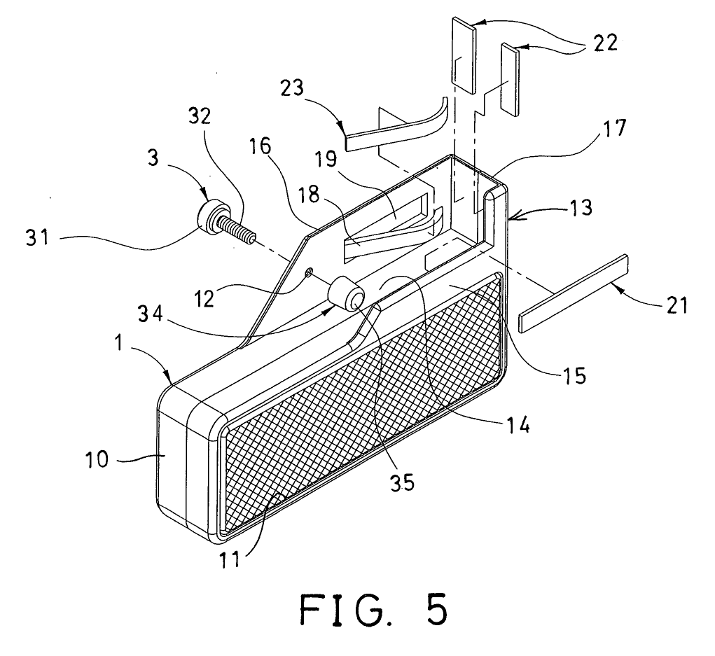

The casing 13 may further include one or more screw holes 12 formed in either or both of the side plates 15, 16 (FIG. 5). One or more fasteners 3 may further be provided and each includes a knob 31 and a threaded shank 32 extended therefrom for threading with the screw holes 12 of the casing 13, and for engaging with the monitor 5 of the notebook computer, to further solidly secure the casing 13 and thus the housing 10 of the speaker device 1 to the monitor 5 of the notebook computer.

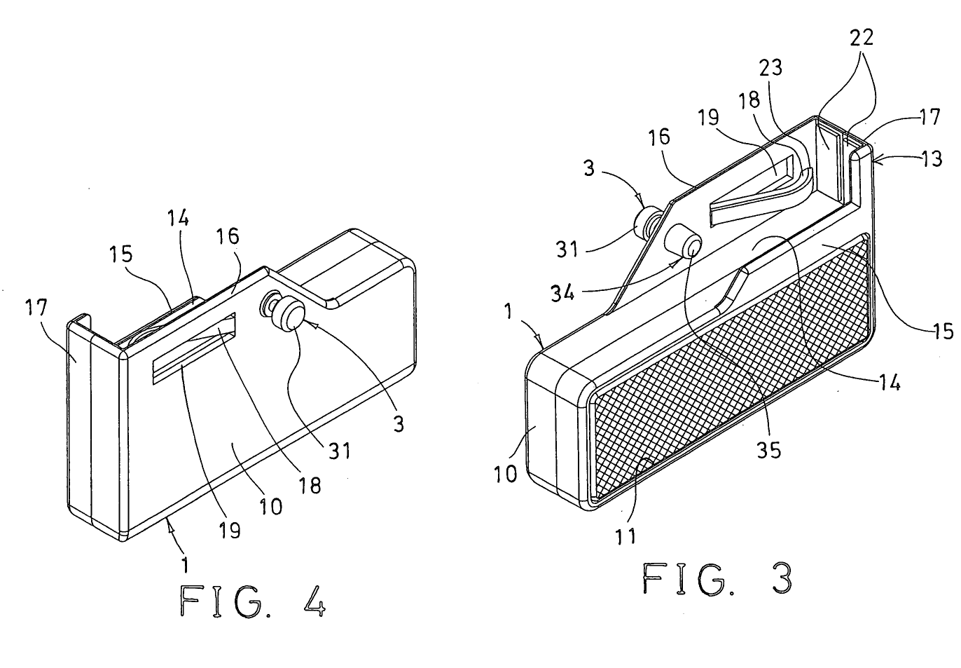

A follower 34 may further be provided and engaged or threaded onto the threaded shank 32 of the fastener 3 (FIGS. 3, 5, 7), and may include a pad 35 attached thereto (FIGS. 3, 5). The pads 35 of the followers 34 may be engaged onto the peripheral frame 52 of the monitor 5, to protect the peripheral frame 52 of the monitor 5 from being damaged by the threaded shank 32 of the fastener 3.

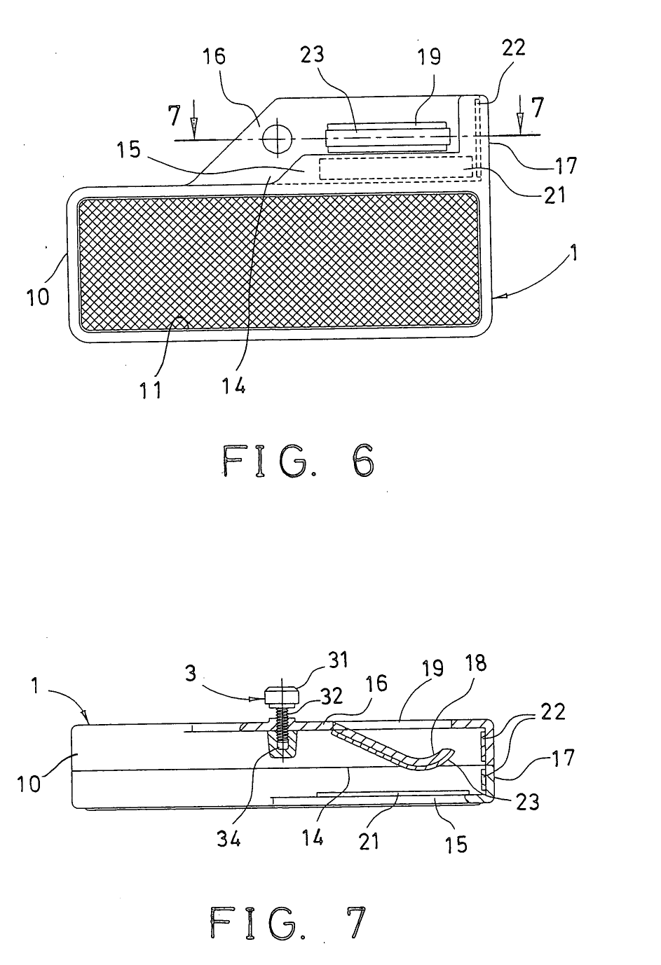

As shown in FIGS. 2-7, each of the casings 13 may further include one or more spring blade 18 extended into the space 14 thereof, from either of the plates 15-17, such as extended from the side plate 16, to resiliently engage with the peripheral frame 52 of the monitor 5, and to further resiliently or solidly attach or secure the speaker device 1 to the peripheral frame 52 of the monitor 5 of the notebook computer.

For example, the spring blade 18 may be formed by punching the side plate 16, to form an opening 19 within the side plate 16, and thus to form the spring blade 18. It is preferable that the spring blade 18 is slightly curved, to prevent the spring blade 18 from scraping or damaging the peripheral frame 52 of the monitor 5 of the notebook computer.

One or more adhesive materials or members 21, 22, 23 may further be provided and attached to either of the plates 15, 16, 17 of the casing 13, and/or to the spring blade 18 (FIGS. 3 and 5-7), to further adhere and secure the casing 13 and thus the housing 10 of the speaker device 1 to the monitor 5 of the notebook computer. The adhesive material or member 23 may further be used to protect the peripheral frame 52 of the monitor 5 from being scraped or damaged by the spring blade 18.

In operation, as shown in FIGS. 1 and 2, one or more speaker devices 1 may be attached onto either of the corner areas 53 of the peripheral frame 52 of the monitor 5 by engaging the corner areas 53 of the peripheral frame 52 of the monitor 5 into the spaces 14 of the casing 13, and/or by the adhesive materials or members 2, and/or by the fasteners 3.

Accordingly, the notebook computer in accordance with the present invention includes a speaker device attachable thereto and detachable therefrom, and the speaker device may include one or more spring blades to resiliently engage with and to solidly attach or secure the speaker device to the peripheral frame of the monitor of the notebook computer.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A notebook computer comprising:
a monitor including a frame,
a speaker device including a housing having a casing, and said casing including a space formed therein to receive said frame and to attach said casing and said housing to said frame of said monitor, and
said speaker device including at least one spring blade extended therefrom, to engage with said frame of said monitor, and to secure said speaker device to said monitor.

2. The notebook computer as claimed in claim 1, wherein said casing includes two side plates to define said space thereof and to receive said frame.

3. The notebook computer as claimed in claim 2, wherein said at least one spring blade is extended from either of said side plates of said casing.

4. The notebook computer as claimed in claim 3, wherein either of said side plates includes an opening formed therein to form said at least one spring blade.

5. The notebook computer as claimed in claim 1 further comprising at least one adhesive member attached to said casing, to engage with and to secure said casing to said frame of said monitor.

6. The notebook computer as claimed in claim 5, wherein said casing includes two side plates and an upper plate to define said space thereof and to receive said frame, said at least one adhesive member is attached to either of said plates of said casing.

7. The notebook computer as claimed in claim 1 further comprising an adhesive member attached to said at least one spring blade, for engaging with said frame of said monitor, and for further securing said casing to said frame of said monitor.

8. The notebook computer as claimed in claim 1 further comprising means for securing said casing to said frame of said monitor.

9. The notebook computer as claimed in claim 8, wherein said securing means includes at least one fastener engaged through said casing and engaged with said frame of said monitor, to secure said casing and said housing to said frame of said monitor.

10. The notebook computer as claimed in claim 9, wherein said casing includes at least one plate to define said space thereof and to receive said frame, said at least one fastener is engaged through said at least one plate of said casing.

11. The notebook computer as claimed in claim 9, wherein said at least one fastener includes a knob and a threaded shank extended from said knob to engage through said at least one plate of said casing.

12. The notebook computer as claimed in claim 11, wherein said at least one fastener includes a follower attached to said threaded shank, to engage with said frame of said monitor.

13. The notebook computer as claimed in claim 12, wherein said follower includes a pad attached thereto, to engage with said frame of said monitor.
